(19) United States
(12) Patent Application Publication
(10) Pub. No.: US 2006/0290930 A1
(43) Pub. Date: Dec. 28, 2006

(54) Method and apparatus for inspecting pattern defects

(76) Inventors: Hidetoshi Nishiyama, Fujisawa (JP); Yukihiro Shibata, Fujisawa (JP); Shunji Maeda, Yokohama (JP); Sachio Uto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/434,070

(22) Filed: May 16, 2006

(30) Foreign Application Priority Data
May 18, 2005 (JP) 2005-144817

(51) Int. Cl. G01N 21/00

(52) U.S. Cl. 356/338

(57) ABSTRACT

The present invention relates to a pattern defect inspection apparatus, wherein light emitted from an illumination source capable of outputting a plurality of wavelengths is linearly illuminated by an illuminating optical system. Diffracted or scattered light due to a circuit pattern or defect on a wafer is collected by an imaging optical system onto a line sensor and converted into a digital signal, and the defect is detected by a signal processing section. Then, the defect can be detected with high sensitivity since a surface to be formed by an optical axis of the illuminating optical system and an optical axis of the imaging optical system is almost collimated to a direction of a wiring pattern and further since an angle to be formed by the optical axis of the imaging optical system and the wafer is set to an angle with less diffracted light from the pattern. Thereby, the pattern defect inspection detecting various defects on the wafer with high sensitivity at high speed can be achieved.

### CROSS-REFERENCE TO RELATED APPLICATION

The present application claims priority from Japanese patent application No. JP 2005-144817 filed on May 18, 2005, the content of which is hereby incorporated by reference into this application.

### BACKGROUND OF THE INVENTION

This invention relates to a pattern defect/foreign-matter inspection technology for detecting defects and foreign matters of a circuit pattern on a sample and, more specifically, to a technology effectively applicable to a method and an apparatus for inspecting pattern defects, which inspect the defects and foreign matters in the circuit pattern such as a semiconductor wafer, a liquid crystal display, and a photomask, etc. with high sensitivity at high speed.

Japanese Patent Laid-Open Publication No. 61-212708 describes a defect inspection apparatus for detecting defects and foreign matters in a circuit pattern on a sample, wherein an imaging device such as an image sensor takes an image of the sample while moving the sample, compares shading of a sensed image signal with that of an image signal that has been delayed for a certain duration, and recognizes any mismatched area as a defect.

In addition, as another technology for defect inspection of a sample, Japanese Patent Laid-Open Publication No. 8-320294 discloses a technology of detecting defects with high accuracy in a semiconductor wafer in which an area with a high pattern density such as a memory mat section and an area with a low pattern density such as a peripheral circuit are mixed in the same die. With this technology, brightness or contrast of the high density area and that of the low density area of a pattern to be inspected is computed, an image signal is corrected so as to satisfy a predetermined relationship, and comparison of images is carried out based on the corrected image signal.

In addition, as a technology of inspecting a circuit pattern of a photomask, Japanese Patent Laid-Open Publication No. 10-78668 discloses a technology of using an UV (ultraviolet) laser beam such as excimer laser as a light source, uniformly illuminating a mask with light whose coherence is reduced by rotating a diffused panel inserted in an optical path, computing a characteristic amount from image data of the obtained mask, and then determining whether the photomask is good or not.

In addition, as a system of inspecting a surface of a sample, Japanese Patent Laid-open Publication No. 2001-512237 discloses a technology of illuminating a line from an oblique incidence angle and detecting light from a portion corresponding to the line.

In addition, as an inspection system for semiconductor wafers and reticles, Japanese Patent Laid-open Publication No. 2002-544477 discloses a technology of such illumination as to compensate for an angle of 45 degrees with respect to vertical and horizontal axes of the wafer.

### SUMMARY OF THE INVENTION

In recent LSI manufacture, due to miniaturization of circuit patterns that correspond to need for higher integration, width of a wiring pattern to be formed on the wafer has been ever decreasing. On the one hand, height of the wiring pattern has increased to ensure conductivity of a wiring, and thus an aspect ratio of height/width has reached 3 to 4. In response to this, miniaturization of each size of the defect inspection apparatus and the defect to be inspected are also demanded.

In this context, for the defect inspection apparatus, making an NA (Numerical Aperture) of an objective lens for inspection higher or developing an optical super-resolution technology has been under way. However, making the NA of the objective lens for inspection higher has reached a physical limit, so that a fundamental approach is now to make wavelength of light to be used for inspection shorter in an area in which UV light or DUV (Deep UV) light belongs.

However, LSI devices include memory products to be formed by a repetition pattern with a high density or logic products to be primarily formed by non-repeated patterns, thus a structure of patterns to be inspected becomes complicated and diversified. For this reason, it becomes difficult to find without fail defects (target defects) that need control when an LSI device is manufactured. The target defects whose detection is desirable include voids and scratches that occur in a CMP process, in addition to foreign matters occurring during a manufacturing process and defective shapes of the circuit pattern after etching. In addition, in a gate wiring or a metal wiring section of aluminum etc., there is a short between the wiring patterns (also referred to as a bridge). In particular, since height of the short between the wiring patterns is often smaller than that of the wiring pattern, there is a problem that its detection is difficult.

In an LSI device having multi-layered wirings, in addition to miniaturization of said target defects, since underlying patterns in a place where defects occur are also diversified, inspection becomes more difficult. In particular, in a process in which a transparent film (herein meaning that it is transparent to illumination wavelength) such as an insulating film is exposed on the outermost surface, intensity irregularity of interference light due to a minute difference in thickness between the transparent films becomes optical noise. Thus, there is a problem to actualize the target defects while reducing an influence on the intensity irregularity of the interference light.

In addition, accurate control of defective conditions of LSI devices is needed to manufacture LSI in a stable manner. To this end, inspection of all LSI boards is desirable. Therefore, there is a problem of detecting said target defects in a short time.

The present invention provides an apparatus and a method for inspecting pattern defects, which inspect diverse defects on a wafer with high sensitivity at high speed.

Novel features of the present invention will become apparent from the description of this specification and the accompanying drawings.

Outline of representative ones of the inventions disclosed in the present application will be briefly described as follows.

According to the present invention, in a pattern defect inspection apparatus comprising: an illumination means for illuminating a sample; an imaging means for imaging scattered light from the sample illuminated by the illumination means; a detection means for photoelectrically converting an image of the sample formed by the imaging means; and a signal processing means for processing a signal outputted from the detection means and detecting a defect on the sample, there is achieved a pattern defect inspection method comprising the steps of: illuminating a sample by an illumination means; imaging, by an imaging means, scattered light from the sample illuminated by the illumination means; photoelectrically converting, by a detection means, an image of the sample formed by the imaging means; processing, by a signal processing means, a signal outputted from the detection means; and detecting a defect on the sample, wherein a surface to be formed by an optical axis of the illumination means and an optical axis of the imaging means is almost parallel to a wiring pattern on the sample.

Also according to the present invention, in a pattern defect inspection apparatus comprising: an illumination means for illuminating a sample; an imaging means for imaging scattered light from the sample illuminated by the illumination means; a filtering means for limiting light flux in an optical path of the imaging means; a detection means for photoelectrically converting an image of the sample formed by the light flux passing through the filtering means; and a signal processing means for processing a signal outputted from the detection means and detecting a defect on the sample, there is achieved a pattern defect inspection method comprising the steps of: illuminating a sample by an illumination means; imaging, by an imaging means, scattered light from the sample illuminated by the illumination means; limiting light flux in an optical path of the imaging means by a filtering means; photoelectrically converting, by a detection means, an image of same sample formed by the light flux passing through the filtering means; processing, by a signal processing means, a signal outputted from the detection means; and detecting a defect on the sample, wherein the filtering means selects an area with less diffracted light from a wiring pattern.

Effects obtained from representative ones of the inventions disclosed in the present application will be briefly described as follows.

According to the present invention, various defects on the wafer can be detected with high sensitivity at high speed.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a view for explaining a pattern defect inspection apparatus according to a first embodiment of the present invention.

FIG. 2A is a perspective view illustrating a detection-directional positional relation between a wiring pattern and an inter-wiring short defect.

FIG. 2B is a y-axis sectional view of the wiring pattern and the inter-wiring short defect.

FIG. 2C is a top view of the wiring pattern and the inter-wiring short defect.

FIG. 3 is a view for explaining a mechanism of changing an angle of an imaging optical system in the first embodiment.

FIG. 4A is a view showing a distribution of diffracted light when viewed from a longitudinal direction of the wiring pattern.

FIG. 4B is a view showing a distribution of diffracted light when viewed from a direction in which the wiring patterns are repeated.

FIG. 5 is a view for explaining a sequence of a method of determining an angle of the imaging optical system.

FIG. 6 is a view for explaining a graph to be displayed when the angle of the imaging optical system is determined.

FIG. 7 is a view for explaining another configuration example of a signal processing section.

FIG. 8 is a view for explaining a sequence of a signal processing of the signal processing section.

FIG. 9 is a view for explaining another configuration example of a portion of the imaging optical system when an angle is changed.

FIG. 10 is a view for explaining a case of changing an illumination angle in another example of arrangement of the illuminating optical system and the imaging optical system.

FIG. 11 is a view for explaining a configuration in which a multi-tap line sensor is used.

FIG. 12 is a view for explaining a pattern defect inspection apparatus according to a second embodiment.

FIG. 13A is a view showing an example of an aperture restricting filter in which one small aperture is provided.

FIG. 13B is a view showing an example of an aperture restricting filter in which one large aperture is provided.

FIG. 13C is an example of an aperture restricting filter in which a plurality of apertures are provided.

FIG. 14 is a view for explaining a sequence of a setting method for the aperture restricting filter.

FIG. 15A is a view showing a two-dimensional Fourier transform.

FIG. 15B is a view showing a filter shape.

FIG. 16 is a view for explaining a relation between film thickness of the transparent film and interference light intensity of reflected light by the transparent film.

### DESCRIPTION OF THE PREFERRED EMBODIMENTS

Hereinafter, embodiments of the present invention will be described in detail based on the drawing. Note that, throughout all the drawings for illustrating the embodiments, the same members are denoted by the same reference numerals and repetitious explanation thereof will be omitted.

### First Embodiment

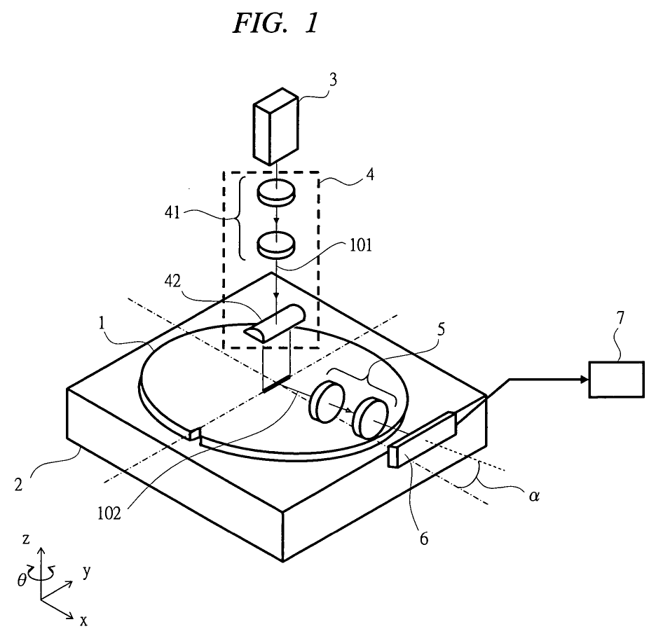

FIG. 1 shows an example of a pattern defect inspection apparatus according to a first embodiment of the present invention. The pattern defect inspection apparatus according to the first embodiment of the present invention comprises a transport system 2 for placing and carrying a wafer 1 to be inspected, an illumination source 3 capable of emitting a plurality of wavelengths, an illuminating optical system 4 serving as an illuminating means for illuminating the wafer 1, an imaging optical system 5 serving as an imaging means for imaging scattered light from the wafer 1 illuminated by the illuminating optical system 4, a line sensor 6 serving as a detection means for photoelectrically converting an image of the wafer 1 formed by the imaging optical system 5, and a signal processing section 7 serving as a signal processing means for processing a signal outputted from the line sensor 6 and for detecting any defects on the wafer 1, wherein the illuminating optical system 4 comprises a relay lens 41 and a cylindrical lens 42.

Light emitted from the illumination source 3 is collimated by the relay lens 41 and linearly condensed onto the wafer 1 by the cylindrical lens 42. The light irradiated by the cylindrical lens 42 is diffracted or scattered by circuit patterns or defects on the wafer 1. Scattered light from the defects is collected on a light receiving surface of the line sensor 6 by the imaging optical system 5 and is converted into a digital signal. Then, any defect is detected by the signal processing section 7.

Herein, the word “linearly” refers to a shape in which an aspect ratio of an illuminated area is approximately two or more (a ratio of longitudinal-directional length to transverse-directional length of the illuminated area is twice or more) and may have any size as long as it is large enough to illuminate a range to be detected by effective pixels of the line sensor 6. The advantage of linearly irradiating the illuminating light is that optical information in a wide range can be obtained once and high-speed inspection becomes possible.

In addition, it is important that the imaging optical system 5 is arranged in a location where the diffracted light from the circuit pattern is not collected or where an amount of receiving light is small. There is a tendency that: the diffracted light from the circuit pattern is most intense to an optical axis 101 of the illuminating optical system 4 in a specular direction; and as order of the diffracted light rises, a diffractive angle to specular light increases and an amount of light decreases. In other words, in the case of epi-illumination from a vertical upwards direction of the wafer 1, since the specular light is directed vertically upwards, the diffracted light through the circuit pattern closer to a horizontal surface is less. Therefore, if an optical axis 102 of the imaging optical system 5 is located at a position where an angle of α is formed above from a surface of the wafer 1, the angle α is desirably within an angle of approximately 2 to 10 degrees. At this time, if it is desired to make the angle α appropriate to the circuit pattern, the axis may be determined at a position where the amount of receiving light from the circuit pattern is least in accordance with a method as described later.

The details of respective portions of the pattern defect inspection apparatus according to the present embodiment will be described below.

First, the transport system 2 has a function of sequentially moving respective areas of the wafer 1 to illuminated areas by holding the wafer 1 and moving it to xyzθ-axial directions. The transport system 2 comprises, for example, an x-axis stage, a y-axis stage, a z-axis stage, a θ-axis stage, and a wafer chuck. The configuration is such that the x-axis stage can travel at constant speed and the y-axis stage can travel stepwise. The z-axis stage has a function of moving the wafer chuck up and down, and the θ-axis stage has a function of rotating the wafer chuck, thus turning the wafer 1 by a predetermined angle with respect to travel directions of the x-axis and y-axis stages. Furthermore the wafer chuck has a function of sucking the wafer 1 by vacuum etc. and holding it.

The illumination source 3 is a laser oscillator or a lamp. For example, a multiple-wavelength laser capable of emitting a plurality of wavelengths is available. In addition, as a lamp, an Xe lamp, an Hg—Xe lamp, an Hg lamp, an extra high pressure Hg lamp, a high pressure Hg lamp, an Electron-Beam-Gas-Emission Lamp (output wavelengths are, for example, 351 nm, 248 nm, 193 nm, 172 nm, 157 nm, 147 nm, 126 nm, and 121 nm), or the like can be used and such a lamp may be arbitrary as long as it can output a desirable wavelength. As a method of selecting the lamp, for example, a lamp whose desirable wavelength output is high may be selected and, at this time, arc length of the lamp is desirably made short.

FIG. 16 illustrates the advantage of using light of multiple wavelengths. FIG. 16 shows a relation between film thickness of a transparent film and interference light intensity of reflected light by the transparent film. In the case of illumination by single wavelength, the interference light intensity changes like a sine wave depending on the film thickness (see a graph of λ1 or λ2 of FIG. 16), and the intensity increases when the film thickness “t” satisfies Expression 1, and decreases when the film thickness “t” satisfies Expression 2. Note that in the Expression 1 and Expression 2, wavelength of illuminated light is assumed as “λ” and “n” is an integer.
t=λ×n, or t=λ×n+λ/2 (Expression 1)
t=λ×n+λ/4, or t=λ×n+λ×3/4 (Expression 2)
As can be seen from the Expression 1 and Expression 2, for a single wavelength, as the wavelength λ becomes shorter, a change in interference intensity becomes sensitive to a change in film thickness.

Now, by utilizing the fact that phases of interference intensity differ for every wavelength, the interference light intensity obtained by adding the wavelength λ1 and the wavelength λ2 different therefrom is a graph of (λ1+λ2) as illustrated in FIG. 16. Since the interference light intensity is formed by two kinds of wavelengths, the interference light intensity is averaged, whereby a range in which the change in the interference intensity is small with respect to the change in the film thickness can be created. Since such a wavelength as to make this interference light intensity small is selected with respect to a range of manufacturing the film thickness of LSI, the inspection apparatus influenced by no interference can be provided. This embodiment has been described by using two kinds of wavelengths, but may be used by combining three or more kinds of wavelengths. The advantage of increasing the number of kinds of wavelengths is that an effect of averaging the interference light intensity can be increased.

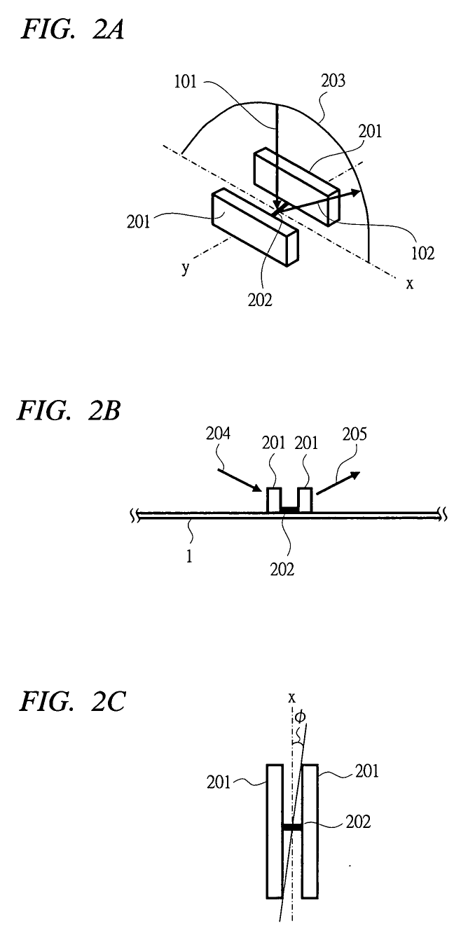

Then, using FIGS. 2A to 2C, a relation between the optical axis 101 of the illuminating optical system 4 and the optical axis 102 of the imaging optical system 5 will be described. FIGS. 2A to 2C each show a detection-directional positional relation between a wiring pattern 201 and an inter-wiring short defect 202, and a detection direction, wherein FIG. 2A is a perspective view; FIG. 2B is a Y-axis sectional view (notation showing a cross section is omitted); and FIG. 2C is a plan view. This embodiment will be described by taking as an example a short defect which is smaller in height than the wiring pattern. However, it may also be applicable to a short defect which is larger in height, for example, a short defect which has the same height as that of a wiring, or also to other foreign matters or defects.

First, with FIG. 2B, a problem of conventional oblique illumination or oblique detection will be described. When the wiring pattern 201 is subjected to oblique illumination 204, a short defect 202 is hidden behind the wiring pattern 201. Thus, illuminating light does not reach the defects, and no scattered light is generated from the short defect 202. In addition, if oblique detection 205 is made, the scattered light from the short defect 202 is shielded by the wiring pattern 201 and cannot be detected by a detector. Thus, it is difficult for an optical system comprising either of them to detect the short defect 202.

For this reason, in FIG. 2A, this embodiment is characterized in that illumination and detection are carried out on the surface 203 including the x axis. Herein, the x axis is almost parallel to the longitudinal direction of the wiring pattern 201. The term “being almost parallel” includes the fact that, as shown in FIG. 2C, it may be arbitrary as long as the x axis is within a range of an angle φ to be formed by a distance between the wiring patterns 201 and by the length of the wiring pattern 201.

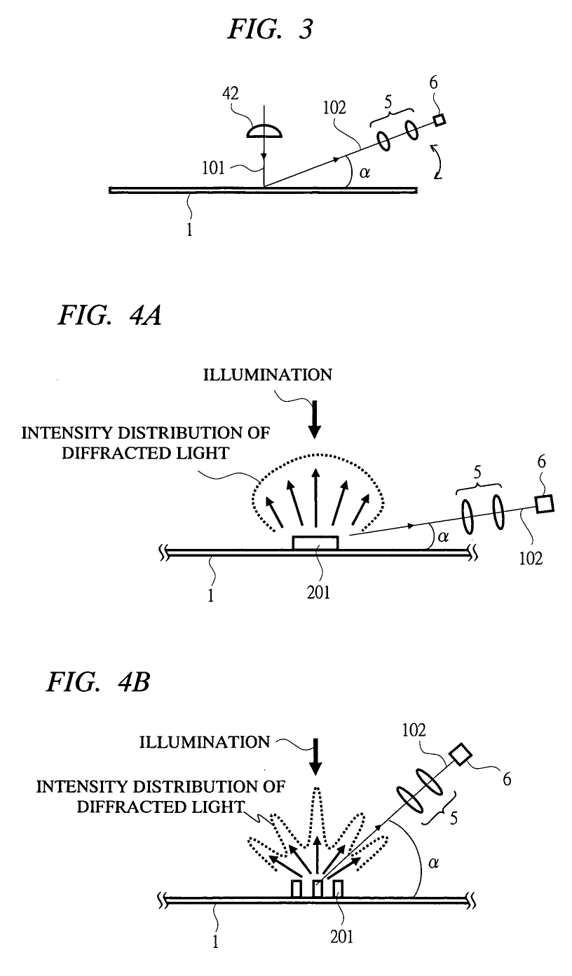

Next, a z-directional position of the imaging optical system 5 will be described. This embodiment is characterized in that the imaging optical system 5 can be moved in a normal-line direction of the wafer 1. In other words, it has a mechanism of changing the angle α as shown in FIG. 3. Herein, the angle α is an angle formed by the optical axis 102 of the imaging optical system 5 and the surface of the wafer 1 with an intersecting point between the optical axis 101 of the illuminating optical system 4 and the wafer 1 being as an apex. Note that although the movement mechanism is not shown, it may be, for example, such a mechanism that the imaging optical system 5 and the line sensor 6 are arranged on a base plate and the base plate is moved up and down with said intersecting point being as a center.

An object of changing the angle to be formed by the optical axis 102 of the imaging optical system 5 and the surface of the wafer 1 is to detect the diffracted light at such an angle that the diffracted light from the wiring pattern is minimized. FIGS. 4A and 4B show one example of a distribution of diffracted light (area marked by wavy lines) on the wiring pattern. FIG. 4A shows an intensity distribution of diffracted light when viewed from a cross section in the longitudinal direction of the wiring pattern. FIG. 4B shows an intensity distribution of diffracted light when viewed from a direction in which the wiring patterns are repeated. If the diffracted light is distributed as shown in FIG. 4A, it is desirable that the angle near the surface of the wafer 1, i.e., the angle α has a small value. In addition, if a plurality of diffracted lights are generated as shown in FIG. 4B, it is desirable to be set to the angle α at which the amount of detected diffracted light is small. However, if FIGS. 4A and 4B are mixed in the same illumination area, it is desirable that the angle α has a small value.

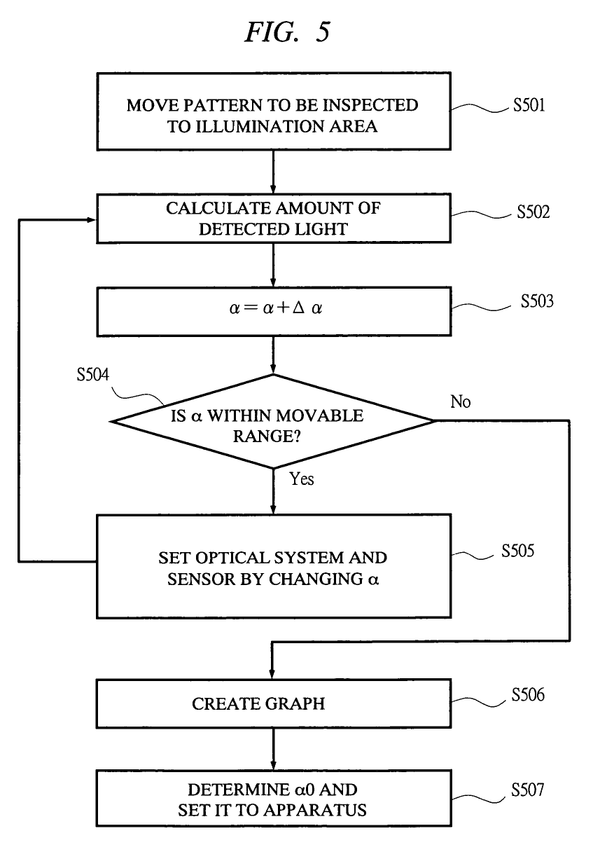

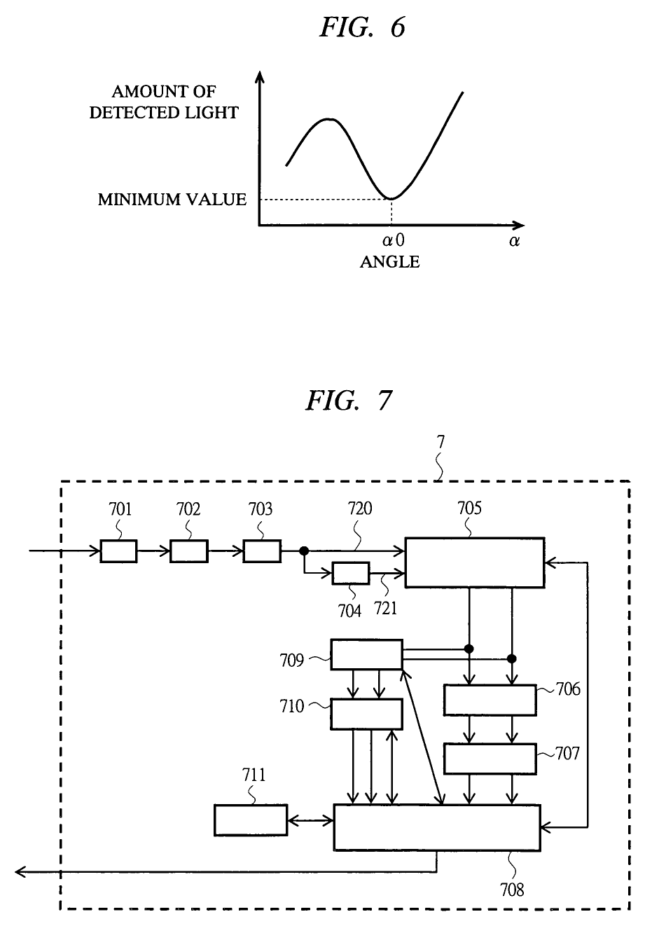

Note that the value of the angle α may be determined through calculation in simulations, etc. or through actual measurement. FIG. 5 shows a sequence of a method of determining the angle of the imaging optical system 5 in the case of the actual measurement. First, a circuit pattern to be inspected on the wafer 1 is moved to an illumination area of the illuminating optical system 4 (S501). At this time, it is desirable to designate a circuit pattern having no defect. Next, diffracted or scattered light from this area is detected by the line sensor 6, and an output of the line sensor 6 is added up (S502). Then, Δα is added to the angle α (S503). Herein, the “Δα” means measurement resolution and may be a value of approximately 2 to 5 degrees. Then, it is judged whether the value of the angle α is within a movable range (S504). If it is within the movable range (Yes), the imaging optical system 5 and the line sensor 6 are set by changing the angle α (S505) and the operation of said S502 is performed. If this judgment is No, a graph of the amount of detected light is created (S506). Lastly, an angle α0 at which the amount of detected light becomes minimum is calculated and is set to the apparatus (S507). Herein, FIG. 6 shows an example of a graph to be displayed when the angle of the imaging optical system 5 is determined. FIG. 6 is a graph in which values of the angle α are plotted on a horizontal axis and the added angles outputted from the line sensor 6 are plotted on a vertical axis. The appropriate angle α may be such that the value α0 at which the amount of detected light of the graph in FIG. 6 becomes a minimum value is taken as an optimum value.

Here, the imaging optical system 5 has a function of collecting diffracted or scattered light from the illumination area and imaging it on the light receiving surface of the line sensor 6.

Next, the line sensor 6 will be described. The line sensor 6 has a function of photoelectrically converting light collected by the imaging optical system 5 and of converting it into A/D (analog/digital). A photoelectrical conversion device is an image sensor, for example, and is one obtained by aligning serially one-dimensional CCD sensors, CMOS type sensors, or photomultipliers. It also may be an image sensor of TDI (Time Delay Integration) type, and may use a two-dimensional CCD sensor such as a TV camera. Note that although an image sensor may be either a surface incident type or a rear incident type, the latter would be desirable if wavelength in the ultraviolet radiation range is collected. In addition, the one-dimensional CCD sensor or TDI image sensor may be a multiple-tap sensor. Herein, the “multiple-tap” indicates that a plurality of output ends of data exist for the number of effective pixels of the CCD sensor. For example, by providing an output end per 64 pixels with respect to the CCD sensor whose effective pixels are 1024 pixels, a charge readout time becomes 64/1024=1/16 times and thus the multiple-tap line sensor can be used 16 times faster in operation speed than the CCD sensor whose output end is one. FIG. 11 shows a configuration in which this multiple-tap line sensor is used. FIG. 11 is an example in which the sensor is divided into 8 taps with respect to the light receiving surface of the line sensor 6. By connecting the signal processing section 7 to each of the 8 taps (output ends), signal processings can be performed in parallel and thus the high-speed inspection can be made.

Then, the signal processing section 7 will be described. The signal processing section 7 processes signals outputted from the line sensor 6, and has a function of detecting the defects. As a method of detecting the defects, for example, there is a method in which a signal exceeding a predetermined threshold with respect to the signal outputted from the line sensor 6 is determined as a defect. At this time, the coordinates of the defect may be determined from a position of the transport system 2. For example, an encoder is attached to the transport system 2, and relative distances from a predetermined origin may be set as the coordinates of the defect.

Next, FIG. 7 shows another configuration example of the signal processing section 7. Said example can be applied to the case in which the amount of light from the circuit patter is sufficiently small as compared with an amount of light from a defect portion, so that this example may be used when the amount of light from the circuit pattern is much.

The signal processing section 7 comprises a tone conversion section 701, a signal filter 702, a delay memory 703, an alignment section 704, a local gradation conversion section 705, a comparison processing section 706, a CPU 707, a point diagram creation section 708, and a storage means 709.

First, an operation thereof will be described. First, a signal obtained at the line sensor 6 is sent to the signal processing section 7, and then is subjected to a tone conversion as described in Japanese Patent Laid-Open Publication No. 8-320294 by the tone conversion section 701. This tone conversion section 701 corrects the signal through a logarithmic conversion, exponential transformation, or polynomial conversion, etc. The signal filter 702 is a filter for efficiently filtering out signal noise inherent in the illumination source from the signal subjected to the tone conversion by the tone conversion section 701. The delay memory 703 is a memory section for storing a reference signal for comparison at a comparison processing section 706 discussed later, and stores output signals obtained from the signal filter 702 and one or more cells or dies of the circuit patterns formed on the wafer 1 to delay communication to subsequent stages. Herein, the “cell” is a unit of repeated circuit patterns in the die. Note that the signal filter 702 may be used after passing through the delay memory 703.

Then, by using a normalization correlation method etc., the alignment section 704 detects an offset of the output signal 720 (inspection signal from wafer 1) obtained from the tone conversion section 701 and a delay signal 721 (reference signal serving as a reference) obtained from the delay memory 703, and performs alignment in terms of pixels. The local tone conversion section 705 performs a tone conversion to both or one of signals different in a characteristic amount (brightness; or a differential value, a standard deviation, or texture, etc. to be calculated when a pixel is configured from signals) so as to match the characteristic amounts with each other. In addition, the comparison processing section 706 detects the defect based on a difference of the characteristic amount by comparing mutually the detection signals subjected to the tone conversion by the local tone conversion section 705. In other words, the comparison processing section 706 compares the reference signal delayed up to an amount corresponding to a cell pitch etc. outputted from the delay memory 703 and the detection signal. Note that the details of the comparison processing section 706 may be the technology as disclosed in Japanese Patent Laid-Open Publication No. 61-212708, and comprises, for example, an image alignment circuit, a difference image detection circuit of aligned images, a circuit for binarizing the difference image to detect a mismatch, and a characteristic extraction circuit for calculating an area, a length (projected length), and a coordinate, etc. from the binarized output.

The point diagram creation section 708 has a function of creating a point diagram of the characteristic amount of the inspection signal and that of the reference signal, and displays it in an input/output section (not shown) by way of a CPU 707.

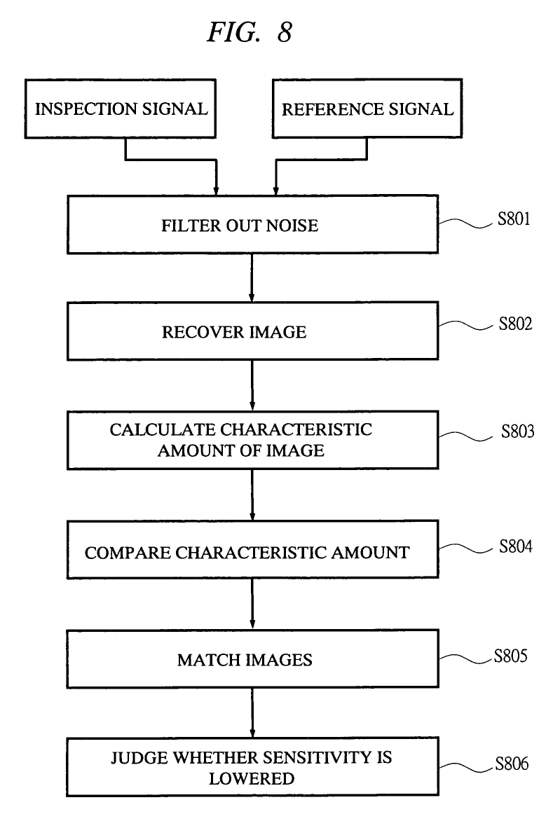

FIG. 8 shows one example of a sequence of a signal processing of the signal processing section 7. First, it improves an S/N of an image signal through a noise removal processing (S801) on the inputted inspection/reference signal if necessary. For filtering out the noise, various types of filters are prepared and can be selected depending on quality of an object or quality of noise. For example, there is a method of weighting a value of a pixel located near a pixel to be noted to average it or a method of filtering out the regularly occurring noise by using a median filter or Fourier transform.

Then, a recovery processing (S802) to deteriorated images is performed by filtering out the noise. For example, the recovery processing is performed by a Wiener filter. Next, it is checked whether there is any big difference in picture quality between the inspection image and the reference image to be compared. Evaluation indices include contrast, fluctuations in brightness (standard deviation), and frequency of noise component, etc. A processing of calculating the characteristic amount (S803) calculates the evaluation indices of images, and then an image matching processing (805) is performed based on a result of a processing (S804) of comparing the computed characteristic amounts. If the image matching processing is at a level of incapable of matching the characteristic amounts, the comparison processing section 706 tries to suppress an occurrence of misinformation by lowering sensitivity. Then, a defect detection judgment (a judgment of whether sensitivity is lowered) carried out (S806). Note that a detailed defect detection method by the signal processing section 7 is, for example, a method as disclosed in Japanese Patent Laid-Open Publication No. 2001-194323.

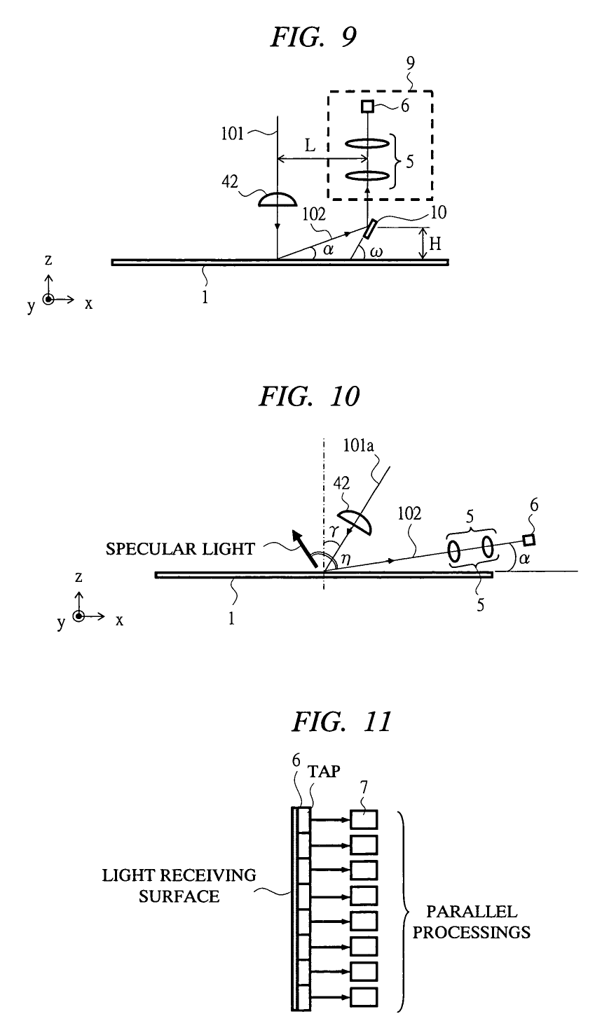

Next, another configuration example of a portion of the imaging optical system will be described. FIG. 9 shows another example of a method of collecting the scattered light from the wafer 1 by changing the angle α. In FIG. 9, the imaging optical system 5 and the line sensor 6 are combined for simplicity of the below-mentioned description and abbreviated as a detection optical system 9. The detection optical system 9 can move in the z-axis direction by a mechanism not shown. In addition, a mirror 10 can move in the z-axis direction and rotated around a y axis.

A method of arranging the detection optical system 9 and the mirror 10 will be described. For example, there is described the case in which the angle formed by the optical axis 102 of the imaging optical system and the surface of the wafer 1 is set to “α” [degrees]. Assuming that the angle to be formed by a plane of the mirror 10 and the surface of the wafer 1 is “ω” [degrees]; a distance between the optical axis 101 of the illuminating optical system and the optical axis 102 of the imaging optical system is “L”; and height of the mirror 10 is “H”, the mirror 10 is arranged at a position to be calculated from Expression 3 and Expression 4 and the z-axis direction of the detection optical system 9 may be determined so that a focal position on an object side of the imaging optical system 5 is located at an intersecting point of the optical axis 101 of the illuminating optical system and the optical axis 102 of the imaging optical system. The advantage of this method is that width of the apparatus can be made small.
ω=45+α/2 (Expression 3)
H=L×tan(α) (Expression 4)

FIG. 10 shows another example of arrangement of the illuminating optical system and the imaging optical system, wherein the illumination angle is changed. FIG. 10 shows the example in which the optical axis 101a of the illuminating optical system is angled in the x-axis direction by an angle γ with respect to the nominal line of the wafer 1. At this time, the angle to be formed by the optical axis 101a of the illuminating optical system and the optical axis 102 of the imaging optical system is 90 degrees or less. The advantage of this configuration is that since an angle η between the specular light from the wiring pattern of the wafer 1 and the optical axis 102 of the imaging optical system becomes large, the diffracted light from the wiring pattern of the wafer 1 can be reduced.

From the foregoing description, if the configuration as described in the first embodiment is adopted, it is possible to linearly irradiate illumination light with the plurality of wavelengths onto the wafer, collect the scattered light from the defect without detecting any diffracted light from the circuit pattern, and inspect the defects of various LSI patterns with high sensitivity at high speed. In particular, this is effective for the inter-wiring short defects.

### Second Embodiment

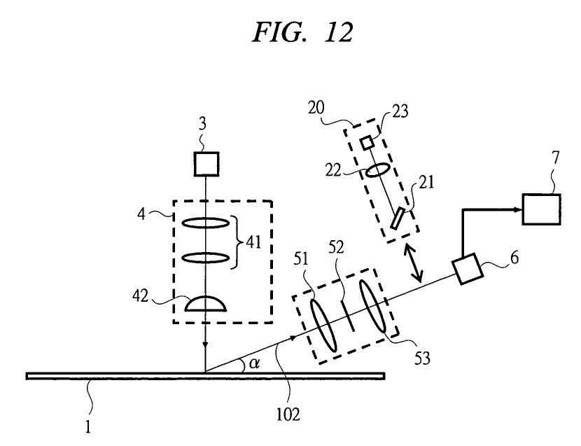

FIG. 12 shows one example of a pattern defect inspection apparatus according to a second embodiment of the present invention. The pattern defect inspection apparatus of the present embodiment comprises a transport system 2 for placing and moving a wafer 1 to be inspected, an illumination source 3 capable of emitting a plurality of wavelengths, an illuminating optical system 4, an imaging optical system 5, a line sensor 6, a signal processing section 7, and an observation optical system 20. Among them, the illuminating optical system 4 comprises a relay lens 41 and a cylindrical lens 42, and the imaging optical system 5 comprises a Fourier transform lens 51, an aperture restricting filter 52 that is a filtering means for limiting light flux in a light path of the imaging optical system 5, and an inverse Fourier transform lens 53. In addition, the observation optical system 20 comprises a mirror 21, a relay lens 22, and a TV camera 23, and has a mechanism capable of insertion into and retreat from the optical axis 102 of the imaging optical system 5.

Next, an operation of the pattern defect inspection apparatus according to this embodiment will be described. Light emitted from the illumination source 3 is collimated at the relay lens 41 and linearly condensed onto the wafer 1 by the cylindrical lens 42. Light irradiated by the cylindrical lens 42 is diffracted or scattered by circuit patterns or defects on the wafer 1. The diffracted or scattered light from the circuit patterns or defects is subjected to optical Fourier transform by the Fourier transform lens 51, and light flux is limited by the aperture restricting filter 52. The light that has passed through the aperture restricting filter 52 is condensed onto the line sensor 6 by the inverse Fourier transform lens 53, converted into a digital signal, and the defects are detected at the signal processing section 7.

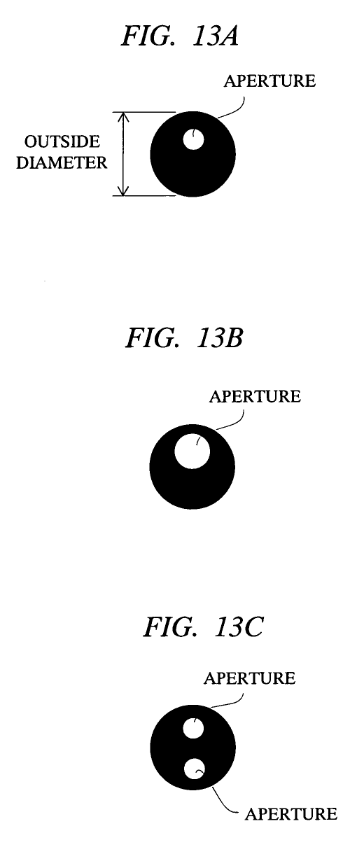

FIGS. 13A to 13C each show a shape of the aperture restricting filter 52. Each outside diameter in FIGS. 13A to 13C is an outside diameter of a Fourier transform surface, wherein a black part represents a light shielded area and an aperture is a light flux transmitting area. FIG. 13A is an example in which one small aperture is provided. FIG. 13B is an example in which a large aperture is provided. In addition, FIG. 13C is an example in which a plurality of apertures are provided. Since a Fourier transformed image represents an angle component of the diffracted or scattered light of the wafer 1, it becomes possible to appropriately select the diffracted or scattered light of the wafer 1 by determining where and how the aperture is to be provided. This corresponds to changing of the angle α of the optical axis 102 of the imaging optical system in said first embodiment (however, a range of collection of the light is within the size of the aperture).

In the configuration of the present embodiment, since selection of the scattered light to be inspected is possible without changing the angle α of the optical axis 102 of the imaging optical system, there is the advantage that adjustment of the optical axis in this embodiment is easier than that of said first embodiment.

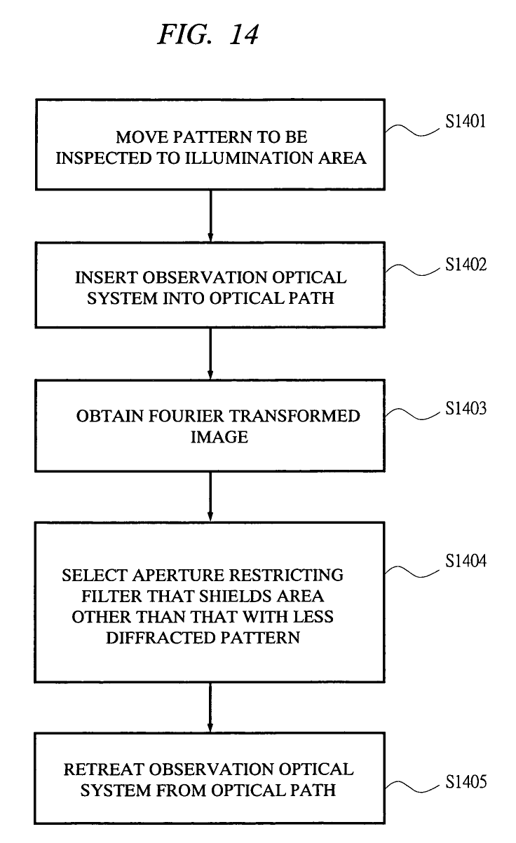

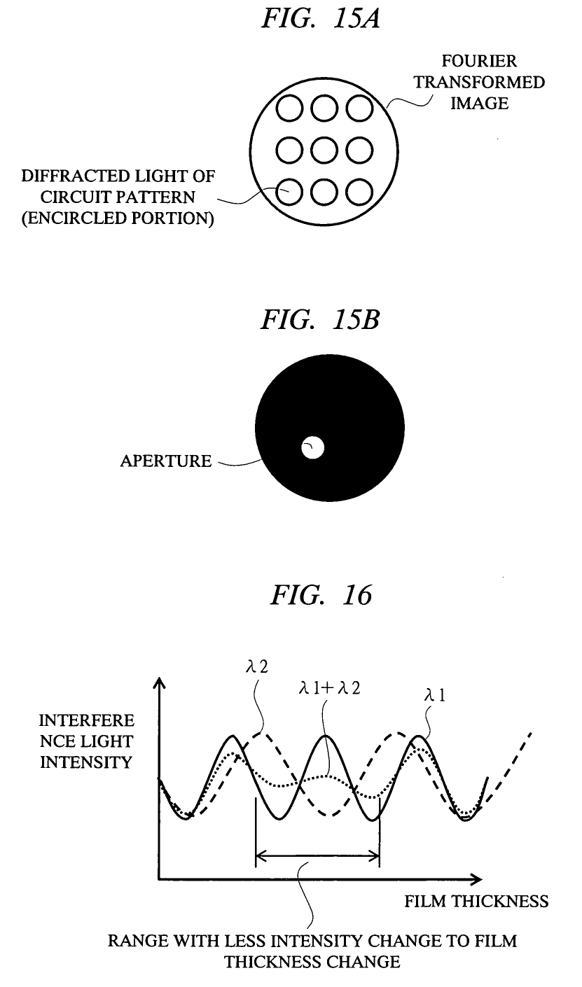

Then, a sequence of a method of setting the aperture restricting filter 52 will be described using FIG. 14. First, a desired circuit pattern on the wafer 1 is moved to the illuminated area (S1401). At this time, although it is desirable to designate an area including no defect, an area containing any defects may also be applied. This is because the amount of diffracted light from the circuit pattern is extremely larger than the amount of scattered light from the defects and thus a position of the diffracted light in the circuit pattern can be easily distinguished from that of the scattered light from the defect. Then, the observation optical system 20 is moved and inserted into the optical axis 102 of the imaging optical system (S1402). This area is illuminated and a Fourier transformed image is obtained by the TV camera 23 (S1403). The image obtained here is, for example, an image as shown in FIG. 15A (For simplicity of the description, a filter shape at a time of obtaining a two-dimensional Fourier transformed image is shown). Then, a filter is selected (S1404) in which an aperture is provided in a location where no diffracted light from the circuit pattern is detected. For example, it is a filter as shown in FIG. 15B. This filter has an aperture provided at a location where the diffracted light from the circuit pattern in FIG. 15A is almost contained. Lastly, the observation optical system 20 is retreated from the optical axis 102 (S1405), and then its setting is ended.

Thus, if the configuration as described in the second embodiment is adopted, similarly to said first embodiment, it is possible to linearly irradiate the illumination light with the plurality of wavelengths onto the wafer, collect the scattered light from the defects, detect little the diffracted light from the circuit pattern, and inspect the defects of various kinds of LSI patterns with high sensitivity at high speed. In particular, this is effective for the inter-wiring short defects.

In the above, although the invention made by the inventors has been specifically described based on the embodiments, it is needless to say that the present invention is not limited to said embodiments and may be variously altered and modified within a rage of not departing from the gist thereof.

For example, in said embodiment, although linear illumination is implemented with the cylindrical lens 42, the cylindrical lens is not necessarily used and the linear illumination may be implemented with any other optical lens. Or, the linear illumination may be implemented by installing a diaphragm in the optical path of the illuminating optical system 4. Or, rectangular illumination may be used if its illuminance is adequate.

In addition, in said embodiment, although the illuminating optical system with the plurality of wavelengths has been described, one of the plurality of wavelengths may be selected if film thickness of an insulating film of a sample is stabilized and an influence on interference light due to a thin film is small. Or, a light source with a single wavelength may be used. Since the contents of the present invention can be applied to a sample in which wiring patterns exist, it is also applicable to a sample in which a vertically long pattern (almost parallel to a long side of a die) and a horizontally long pattern (almost parallel to a shorter side of a die) are mixed.

The present invention is also applicable to any wiring pattern directed in a direction of 45 degrees or 30 degrees, i.e., any direction of dividing, into two, an angle formed by a longer side and a shorter side of a die. For example, if the present invention is applied to a wiring pattern directed in the direction of 45 degrees, a sample is rotated in the direction of 45 degrees so that a longitudinal direction of the wiring pattern is almost parallel to the x-axis direction of the transport system 2, whereby the inspection with high sensitivity can be achieved by applying the present invention. If the sample is rotated, a direction of repeating a die has a predetermined angle to the x-axis direction. At this time, if a die comparison processing is required, as a pitch for carrying out the comparison processing, a value obtained by elongating and contracting a die pitch by the predetermined angle may be used.

In addition, the pattern defect inspection apparatus of this invention may also have a configuration of illumination and detection in multiple directions. In the configuration of illumination in the multiple directions, illumination can be carried out by arranging respective illuminating optical systems at positions with different angles and using the illuminating optical system arranged at the optimal position, rather than the configuration in which the illumination angle as shown in FIG. 10 is changed. In this case, it is more preferable that wavelengths can be changed in the respective illuminating optical systems. In addition, in the detection directed in the multiple directions, detection can be carried out by arranging the respective imaging optical systems at positions with different angles and using the imaging optical system arranged at the optimal position, rather than the configuration in which the angle of the imaging optical system as shown in FIG. 4B is changed.

A sample to be inspected is not limited to a semiconductor wafer, and the present invention can be widely applied to inspection of defects and foreign matters on a circuit pattern, such as a liquid crystal display and a photomask.

The present invention relates to a pattern defect inspection/foreign-matter inspection technology for detecting any defects and foreign matters of a circuit pattern on a sample and, more specifically, is effectively applicable to a pattern defect inspection apparatus and method for inspecting, with high sensitivity at high speed, any defects and foreign matters in a circuit pattern such as a semiconductor wafer, a liquid crystal display, and a photomask.

The invention may be embodied in other specific forms without departing from the spirit or essential characteristics thereof. The present embodiment is therefore to be considered in all respects as illustrative and not restrictive the scope of the invention being indicated by the appended claims rather than by the foregoing description and all changes which come within the meaning and range of equivalency of the claims are therefore intended to be embraced therein.

What is claimed is:

1. A pattern defect inspection apparatus comprising:
an illumination means for illuminating a sample;
an imaging means for imaging scattered light from the sample illuminated by the illumination means;
a detection means for photoelectrically converting an image of the sample formed by the imaging means; and
a signal processing means for processing a signal outputted from the detection means and detecting defects on the sample,
wherein a surface to be formed by an optical axis of the illumination means and an optical axis of the imaging means is almost parallel to a wiring pattern on the sample.

2. The pattern defect inspection apparatus according to claim 1,
wherein the illumination means is capable of emitting a plurality of wavelengths.

3. The pattern defect inspection apparatus according to claim 1,
wherein an illumination shape by the illumination means is linear.

4. The pattern defect inspection apparatus according to claim 1,
wherein the imaging means is movable in a direction of a normal line of the sample.

5. A pattern defect inspection apparatus comprising:
an illumination means for illuminating a sample;
an imaging means for imaging scattered light from the sample illuminated by the illumination means;
a filtering means for limiting light flux in an optical path of the imaging means;
a detection means for photoelectrically converting an image of the sample formed by the light flux passing through the filtering means; and
a signal processing means for processing a signal outputted from the detection means and detecting defects on the sample,
wherein the filtering means selects an area with less diffracted light from wiring patterns on the sample.

6. The pattern defect inspection apparatus according to claim 5,
wherein the illumination means is capable of emitting a plurality of wavelengths.

7. The pattern defect inspection apparatus according to claim 5,
wherein an illumination shape by the illumination means is linear.

8. The pattern defect inspection apparatus according to claim 5,
wherein the imaging means is movable in a direction of a normal line of the sample.

9. A pattern defect inspection method comprising the steps of:
illuminating a sample by an illumination means;
imaging, by an imaging means, scattered light from the sample illuminated by the illumination means;
photoelectrically converting, by a detection means, an image of the sample formed by the imaging means;
processing, by a signal processing means, a signal outputted from the detection means; and
detecting defects on the sample,
wherein a surface to be formed by an optical axis of the illumination means in the illuminating step and an optical axis of the imaging means in the imaging step are almost parallel to a wiring pattern on the sample.

10. The pattern defect inspection method according to claim 9,
wherein in the illuminating step, the illumination means is capable of emitting a plurality of wavelengths.

11. The pattern defect inspection method according to claim 9,
wherein in the illuminating step, an illumination shape by the illumination means is linear.

12. The pattern defect inspection method according to claim 9,
wherein in the imaging step, the imaging means is movable in a direction of a normal line of the sample.

13. A pattern defect inspection method comprising the steps of:
illuminating a sample by an illumination means;
imaging, by an imaging means, scattered light from the sample illuminated by the illumination means;
limiting light flux in an optical path of the imaging means by a filtering means;
photoelectrically converting, by a detection means, an image of same sample formed by the light flux passing through the filtering means;
processing, by a signal processing means, a signal outputted from the detection means; and
detecting defects on the sample,
wherein in the step of limiting the light flux by the filtering means, the filtering means selects an area with less diffracted light from wiring patterns on the sample.

14. The pattern defect inspection method according to claim 13,
wherein in the illuminating step, the illumination means is capable of emitting a plurality of wavelengths.

15. The pattern defect inspection method according to claim 13,
wherein in the illuminating step, an illumination shape by the illumination means is linear.

16. The pattern defect inspection method according to claim 13,
wherein in the imaging step, the imaging means is movable in a direction of a normal line of the sample.
